(19) United States
(12) Patent Application Publication
(10) Pub. No.: US 2003/0149154 A1
(43) Pub. Date: Aug. 7, 2003

(54) Method for producing nanoreinforced thermoplastic polymers

(76) Inventors: Klaus Heinemann, Rudolstadt (DE); Eberhard Taeger, Rudolstadt (DE); Erich Meusel, Katzhutte (DE); Wolfgang Mueller, Rudolstadt (DE)

Correspondence Address: ProPat, Crosby Building, 2912 Crosby Road, Charlotte, NC, 28211-2815, US

(21) Appl. No.: 10/311,141

(22) PCT Filed: Jun. 14, 2001
(86) PCT No.: PCT/DE01/02192

(30) Foreign Application Priority Data
Jun. 14, 2000 (DE) 100 29 103.1
Jun. 13, 2001 (DE) 100 28 356.3

(51) Int. Cl. C08K 3/34

(52) U.S. Cl. 524/442

(57) ABSTRACT

This invention relates to the use of organophilic, swellable specially modified phyllosilicates in the production of nano-reinforced thermoplastic polymers, preferably polyamides, polyesters and polycarbonates. The inorganic phyllosilicate particles are bonded to or incorporated into the polymer in a covalent manner with nanodistribution. Special modification enables the phyllosilicates to be used as initiators in the case of polymerization or a chain elements in the case of condensation. The covalent bonding of the phyllosilicate particles to the polymer increases the stability of the reinforcing effect as opposed to an ionic bond. The special modification is performed for phyllosilicates which become hydrophobic as a result of cationic exchange. This property makes it possible for certain organic reaction partners to reach reactive groups present on the surface of the phyllosilicate and to react therewith on certain conditions. As a result of the functional groups containing organically modified phyllosilicats arising from the reaction, they are able to form stable, covalent bonds with the polymers.

This invention relates to a process for producing nano-reinforced thermoplastic polymers, preferably polyamides, polyesters or polycarbonates, that are improved in the chemical stability of their properties by covalent bonding to or direct incorporation of specifically modified sheet-silicate particles in nano distribution. The sheet-silicates used are natural and/or synthetic products rendered organophilic by cation exchange.

### BACKGROUND OF THE INVENTION

The use of organophilic sheet-silicates as filling and reinforcing agents for polymers is known from the literature. Toyota's first attempts in the 1980's laid the groundwork for a process (DE 36 32 865 and U.S. Pat. No. 4,810,734) which is still being employed today. Its essential steps involve a hydrophilic sheet-silicate being rendered swellable for monomers or polymers by ion exchange by means of inorganic ions or organic cations such as dodecylammonium ions which may additionally bear a carboxyl group. Thus modified sheet-silicates are mixed with the monomer, so that penetration of the monomer between the layers causes layer expansion. The subsequent polymerization of the monomer causes the resulting polymer to become bound, for example via amide bonds, to the inorganic or organic cations which are introduced by the exchange and which in turn are linked to the sheet-silicate via ionic bonds.

These ionic bonds are susceptible to chemical attack under conditions where the covalent bonds are very stable, so that the close connection between sheet-silicate and polymer is instable.

A review article (Zilg, Reichert, Dietsche, Engelhardt, Mulhaupt; Kunststoffe 88, 1988, 1812-1820) deals at length with the approach described and the resulting diverse performance potential of the nanocomposites.

DE 44 05 745 describes the simple mechanical encapsulation of finely divided fillers by a polyester formed in situ from carboxylic anhydrides and oxiranes. The composition of the components is similar in DE 199 20 879. Here too the in situ preparation of polyesters from carboxylic acids or anhydrides and oxiranes is pointed up as characterizing, albeit with the difference that the oxirane groups can also react with the modifier of the inorganic filler or with the modified filler. However, the process described in this patent contains no suggestion of a covalent bond between the inorganic filler and the polymer. In DE 199 05 503 too the thermoplastic and the sheet-silicate are linked exclusively via ionic groups. The carboxylic acids or anhydrides used serve as monomers in order to form the ionic groups on the thermoplastic. It is a common feature of all these solutions that the bond between the inorganic sheet-silicate and the polymer is not covalent and thus lacks stability.

Another way to prepare nanocomposites is described in an AlliedSignal patent (WO 9311190). In this reference, sheet-silicates are modified with suitable reagents, for example organic ammonium ions, in a conventional manner and treated with organosilanes which bear functional groups. What is essential is that one species of the reactive groups of the organosilane forms covalent bonds with the surface of the intercalated lamellae of the sheet-silicate, while the other reactive groups of the organosilane form the covalent bond to the corresponding polymer or its precursors. The result of the process is a polymer which is covalently bonded to the sheet-silicate via an intermediate link. Useful polymer matrices for this method are said by the patent to be polyamides, polyesters, polyolefins and polyvinyl compounds.

The process described therein establishes the covalent link between the polymer and the mineral via an organosilane acting as an intermediate. This process has to be considered relatively costly with regard to the connecting intermediate link. Another disadvantage is that the average bonding energy of the Si—C bond, which forms the direct or indirect link to the polymer, is distinctly less than that of C—C and C—O bonds.

A covalent bond between a sheet-silicate surface and (in this case) a thin polymer layer is likewise described in U.S. Pat. No. 4,480,005. The purpose of the process is to produce a reinforcing material for polymers which consists of a particulate or fibrous mineral component having a “polymer-interactive” layer on these particles. The covalent bond is produced by reacting certain reactive sites on the mineral surface with suitable reactive groups on an organic compound. The reactive group on the mineral surface is typically a hydroxyl group. By “polymer-interactive” segment of the organic compound is meant a segment of considerable length that is capable of behaving in a polymer melt as though it were part of the polymer. The addition of the reinforcing material to polymers is said to produce a positive effect on the performance profile of the polymers. True, the particulate or fibrous mineral component used is a sheet-silicate, but this sheet-silicate is not swellable. The reported aspect ratio of 20 to 200 applies to particle dimensions of 100 to 1000 μm in length and width coupled with layer thicknesses of 1 to 6 μm.

The '005 method of using a mineral reinforcing material with a thin polymer layer in the abovementioned dimensions does not exhaust the possible ways of improving the properties of polymers despite the small particle size of the mineral component. Since the mineral used is not swellable, no intercalation is achieved either. Intercalation, however, is the prerequisite for any nanodispersion of the mineral component in the polymer matrix.

### BRIEF DESCRIPTION OF THE INVENTION

It is an object of the present invention to provide a process for producing nano-reinforced thermoplastic polymers, especially polyamides, polyesters or polycarbonates or copolymers thereof, with improved stability of the reinforcing effect, achievable additional improvements in properties, for example improved breaking extension for fibers and filaments, that provides a chemically stable and also inexpensively producible result.

This object is achieved according to the invention when sheet-silicate particles which have been modified using carboxylic acids and/or carboxylic anhydrides and/or anhydrido-bearing liquid-crystalline polyesterimide anhydrides and which are formed by esterifications of the hydroxyl groups of the sheet-silicate and are present in nanodispersion in a melt of appropriate monomers are linked via covalent bonds to the polymer which forms. According to the invention, it is also possible for the sheet-silicate particles modified using carboxylic acids and/or carboxylic anhydrides and/or anhydrido-bearing liquid-crystalline polyesterimide anhydrides to be added to polymers and reacted in the melt.

### DETAILED DESCRIPTION OF THE INVENTION

The inventive process for preparing nano-reinforced thermoplastic polymers comprises the following steps:

modifying a sheet-silicate rendered organophilic by ion exchange by esterifying hydroxyl groups at its surface with carboxylic acids and/or carboxylic anhydrides and/or anhydrido-bearing polyesterimide anhydrides and also, if appropriate, reacting free carboxyl groups of the reaction product with amines;

mixing the specifically modified sheet-silicate in amounts of 0.1-50%, based on the total batch, with the monomer or monomers or the polymers, if appropriate with addition of further substances such as ε-aminocaproic acid, amine salts, cyclohexylamine hydrochloride, water as initiators, alkali or alkaline earth metals, hydrides, hydroxides or carbonates or Grignard compounds as catalysts, -acetylcaprolactam, -caproylcaprolactam, N,N′-tetraacetylhexamethylenediamine as activators;

polymerizing or reacting the mixture at elevated temperatures in the range from 68° C. to 300° C.

The sheet-silicates which can be used in the process of the present invention can be any desired swellable, natural and/or synthetic clay minerals rendered organophilic by ion exchange, particularly phyllosilicates such as montmorillonite, hectorite, illite, vermiculite and/or others. When choosing the sheet-silicates to be used, it should be borne in mind that natural products such as bentonite for example often give rise to a certain pronounced discoloration of the resulting nanocomposite. It is important that the sheet-silicates have been rendered swellable for organic solvents and/or monomers by an exchange of their interlayer cations for suitable organic cations, for example dimethyldistearyl- or dimethyl stearylbenzyl-ammonium ions, and the aspect ratio should be >100. These organophilic sheet-silicates are treated with carboxylic acids and/or carboxylic anhydrides, such as, for example, benzene-1,3,5-tricarboxylic acid, benzene-1,2,4-tricarboxylic acid (trimellitic acid) or its anhydride (trimellitic anhydride), benzene-1,2,4,5-tetracarboxylic acid (pyromellitic acid) or its dianhydrides (pyromellitic dianhydride), 3,3′,4,4′-benzophenonetetracarboxylic dianhydride, maleic anhydride, pentanedioic acid, tetrahydropyran-2,6-dione, 5-(2,5-dioxatetrahydrofuryl)-3-methyl-3-cyclohexane or phthalic anhydrides, and/or anhydrido-bearing polyesterimide anhydrides having a liquid-crystalline character, especially polyesterimide anhydrides having different chain lengths and having terminal and varying numbers of lateral anhydride groups as described in DE 43 42 705, so that one or more hydroxyl groups on the sheet-silicate particles are esterified. The sheet-silicates are swollen with a suitable organic solvent prior to the reaction, so that the hydroxyl groups become accessible to the reaction partners. The reaction partners are selected so that, if necessary, free carboxyl or anhydride groups are still present on the reaction product after the reaction.

The thus modified, organophilic sheet-silicate is optionally treated with an amine in a further step. For this reaction too the modified sheet-silicate is swollen in an organic solvent, for example decane, in order to ensure that the free carboxyl or anhydride groups present may be accessible to the reaction partners. For the reaction which then follows with amines which bear two or more amino groups on the molecule, for example 1,4-diaminobutane, 1,6-diaminohexane, 1,8-diaminooctane, 1,10-diaminodecane, 1,12-diaminododecane, isophoronediamine and so on, the amount added must be chosen so that the reaction product has substantially the same levels of free carboxyl groups and of free amino groups.

The reaction products from the first or the second reaction step are advantageously comminuted, preferably ground, for example in a laboratory mill, in order that they may be more efficiently meterable and easily intercalatable in that form. They are subsequently mixed in amounts of 0.1-50% with the monomers, such as ε-caprolactam, enantholactam, capryllactam, lauryllactam or polyamide-forming combinations of C₆-C₁₂-dicarboxylic acids and/or cycloaliphatic and/or aromatic dicarboxylic acids with C₄-C₁₂-diamines and/or cycloaliphatic and/or aromatic diamines or mixtures thereof and also polyester-forming combinations of aliphatic and/or cycloaliphatic and/or aromatic dicarboxylic acids and diols and possibly further additives and heated to above their melting point. While stirring, the modified organophilic sheet-silicates are swollen and uniformly dispersed in the monomers. In the process, the interlayer spacings are increased by the penetrating monomers.

As the temperature is further raised to the polymerization temperature, the formation of the polymer ensues. In the process, the reactive groups on the modified sheet-silicate used are effective in covalent bonds being constructed between the organic radicals on the nanoparticles and the monomers or the polymers which form. In the case of the preparation of polyamide nanocomposites from lactam monomers, the modified sheet-silicate particles act as addition-polymerization initiators in that the free amino groups are the starting points for chain growth. When the modified sheet-silicates are used in polycondensation reactions, their reactive groups serve as chain building blocks.

The chain length of the polymer nanocomposites of the present invention can be controlled not only by means of the familiar methods but also specifically in addition polymerization reactions via the addition of modified sheet-silicate and hence polymerization initiator. This makes it possible to prepare relatively low molecular weight polymers or oligomers which have different nanoparticle contents depending on the molecular weight. The polymerization time can be up to 24 hours. The course of chain growth can be monitored during the addition polymerization, for example by recording the torque needed to stir the melt. The polymer formed is characterized by the familiar analytical methods. The nanocomposites of the present invention can be machined, dissolved or melted or else suitably recycled without impairing the close bond between polymer and sheet-silicate particles and the distribution of the latter in the polymer. They can be blended with other identical or compatible polymeric species which contain no nanoparticles.

The use of modified sheet-silicates prepared using liquid-crystalline polyesterimide anhydrides to modify the organophilic sheet-silicates provides additional improvements in the properties of the resulting polyamides, polyesters, polycarbonates or other polymers, since the liquid-crystalline portions lead to a micro phase reinforcement and, what is more, act as compatibility mediators between customarily incompatible polymers such as polyamides and polyesters.

The nanocomposites of the present invention, as well as other favourable properties, have improved mechanical properties such as increased stiffness and impact toughness and also higher heat resistance and superior barrier action to the permeation of gases and liquids. To achieve this positive effect, the nanocomposites contain a sheet-silicate fraction between 0.1 and 50% by weight and preferably between 0.5 and 5% by weight.

Embodiments of the invention include aliphatic polyamide fibers and filaments and polyester fibers and filaments, especially polyester fibers and filaments composed of polyethylene terephthalate or polybutylene terephthalate and also of polycarbonates, which contain low levels of the additives described. It is known that fibers and filaments which contain small amounts of additives are processible via melt spinning, depending on the composition of the mixture, and in some instances can give rise to an increased breaking extension in the undrawn yarn for the same takeoff speed. The inventive polymer blends for the production of polyamide, polyester and also polycarbonate fibers and filaments should preferably contain not more than 6% of additives in order to be readily spinnable, and the production process should be very economical owing to the low amount of additive, the wide availability of the additive and a substantial increase in the breaking extension.

It has been determined that, surprisingly, owing to the fraction of liquid-crystalline polyesterimide anhydrides the additives possess a rod-shaped, elongate form even in the unoriented polymer blends which leads to improved spinnability and drawability. It is likewise remarkable that the lateral diameters of the rod-shaped structures are very small. The rod-shaped inclusions have for example a lateral diameter of about 300 to 400 nm, measured in the unoriented molten filaments extruded from the spinneret. What is important is that the diameter is less than 800 nm. Preference is given to a size of less than 600 nm and particularly preferably of less than 400 nm. The present invention is generally useful not only for producing partially oriented yarn (POY) but also for producing fibers, ie staple fibers, which requires distinctly slower spinning but subsequently much more pronounced drawing (as is known from Ullmann's Encyclopedia of Industrial Chemistry, 5^{th} ed., Vol. A10, Fibers, 3. General Production Technology, pages 550 to 561). The economic advance due to the present invention with regard to fiber production is especially evident in a distinctly increased draw ratio on the fiber line as well as the correspondingly higher throughput of the melt-spinning step. The takeoff speed utilized in accordance with the present invention is preferably in the range from 400 to 2,400 m/min for the production of fiber and in the range from 3,000 to 8,000 m/min for the production of POY.

In a particular embodiment of the invention, an organophilic sheet-silicate which contains anhydride groups as a result of modification with a polyesterimide anhydride having a molar mass of >10,000 g/mol is added to a polymer melt, for example a polyamide or polyester melt, in an extruder and extruded following a residence time sufficient for the modified, anhydrido-containing sheet-silicate to become covalently bonded to the polymer. It is further possible for the above specifically modified sheet-silicate to be metered in chip or powder form directly to the polymer chip in a spinning extruder and the molten mixture to be spun subsequently. The polymer, for example polyethylene terephthalate, itself may also already contain the customary additives such as delusterants (titanium dioxide), stabilizers and others.

The inventive composite between polymer and sheet-silicate due to covalent bonds via terminal and lateral anhydride groups on the liquid-crystalline polyesterimide anhydrides provides the resulting polymer with strong resistance to any thermal and mechanical deformation. This is reflected in the high mechanical strength and also the excellent thermal properties of the materials. Their high dimensional stability, abrasion resistance, smooth surface consistency, water imperviousness and water resistance results from the uniform dispersion of the silicate layers. Embrittlement and other difficulties which are inevitable in the case of conventional composite materials containing inorganic additives are eliminated, since the silicate layers are finely dispersed on the order of molecules and are firmly attached to the chains of the organic molecules.

### EXAMPLES

### Example 1

A modified sheet-silicate is prepared using a bentonite rendered organophilic by cation exchange with dimethylstearylbenzylammonium ions.

23.6 g of this commercially available product are dispersed in 330 ml of 2-30 butanone at 60° C. by stirring. After a stirring time of about 30 minutes, the dispersion is cooled to room temperature. It is then admixed with 3.9 g of trimellitic anhydride which are dissolved in 30 ml of 2-butanone and are added dropwise. On completion of the addition, the dispersion is refluxed for 1 hour. It is then cooled to about 60° C., the reflux condenser is exchanged for a Liebig condenser and the solvent is distilled off, a vacuum being applied toward the end of the distillation to remove residual solvent. The product remaining behind is comminuted in a mill. It has a carboxyl group content of 1772 μeq/g.

For the next step, the amidation of the product obtained, 2.8 g of 1,6-diaminohexane are dissolved in 100 ml of decane and heated to 100° C. The product obtained in the previous step is added with stirring. The temperature is then raised to 140° C. over 40 minutes. This is followed by one hour of stirring, during which the product gradually swells. The solvent is then carefully distilled off under reduced pressure. The product remaining behind is powdery. Its carboxyl group content is 1003 μeq/g and its amino group content is 999 μeq/g. 5 g of the thus modified sheet-silicate are mixed with 95 g of caprolactam and 2 g of water and the caprolactam is melted under a 10 ml/min nitrogen stream with stirring. The melt is heated to 260° C. over 40 minutes and polymerized for about 11 hours before being poured out of the stirred vessel. The polymer still contains 15.1% of extractables. It has a carboxyl group content of 127 μeq/g and an amino group content of 53 μeq/g. The relative solution viscosity was found to be 1.73. The polyamide has a melting point of 214° C. Its ash content is 3.30%.

### Example 2

5 g of the sheet-silicate modified in the manner described in Example 1 are mixed with 95 g of caprolactam and 2 g of water and the caprolactam is melted under a 10 ml/min nitrogen stream with stirring. The melt is heated to 260° C. over 40 minutes and polymerized for about 13.5 hours before being poured out of the stirred vessel. The polymer still contains 3.8% of extractables. It has a carboxyl group content of 98.8 μeq/g and an amino group content of 50 μeq/g. The relative solution viscosity was found to be 2.08. The polyamide has a melting point of 217° C. Its ash content is 2.86%.

### Example 3

5 g of the sheet-silicate modified in the manner described in Example 1 are mixed with 95 g of dried caprolactam and the caprolactam is melted under a 10 ml/min nitrogen stream with stirring. After a stirring time of 20 minutes, 10 g of dried, finely pulverulent sodium carbonate and 1.5 g of N,N′-tetraacetylhexamethylenediamine activator are added. The temperature is raised to 220° C. and the melt is treated at 220° C. for 60 minutes.

The polymer is comminuted, extracted with water and dried at 80° C. in a vacuum drying cabinet.

### Example 4

52 g of the modified bentonite prepared similarly to the first step of the modifying procedure in Example 1 are mixed with 161.8 g of adipic acid, 222.8 g of hydroquinone diacetate, 1.2 g of benzoic acid and 0.06 g of magnesium oxide. The mixture is melted at 180° C. by stirring in a slow nitrogen stream. Once a homogeneous melt is present, the temperature is gradually raised in 10° C. increments until 260° C. is attained. In the process, about 130 g of acetic acid pass over. The acetic acid elimination is completed in the course of 2 to 3 hours by applying a vacuum and further raising the temperature to 280° C.

The polyester obtained has a carboxyl group content of 35 μeq/g. Its ash content was found to be 9.48%.

### Example 5

5 g of a hectorite synthetic three-layer mineral rendered organophilic with dimethylstearylbenzylammonium chloride in the manner described in Example 1 are mixed with 18 g of caprolactam and 72 g of nylon 66 salt and the mixture is melted under a 10 ml/min nitrogen stream with stirring. The melt is heated to 265° C. over 40 min and polycondensed for about 7.5 hours before being poured out of the stirred vessel. The copolyamide still contains 1.5% of extractables. It has a carboxyl group content of 70 μeq/g and an amino group content of 52 μeq/g. The relative solution viscosity is 2.11. The copolyamide has a melting point of 216° C.

### Example 6

A modified sheet-silicate is prepared using a bentonite rendered organophilic by cation exchange with dimethylstearylbenzylammonium ions.

23.6 g of this commercially available product are dispersed in 330 ml of 2-butanone at 60° C. by stirring. After a stirring time of about 30 minutes, the dispersion is cooled to room temperature. It is then admixed with 40 g of liquid-crystalline polyesterimide anhydride, which has a molar mass of about 10,000 g/mol and contains 6 anhydride groups per mole, which are dissolved in 300 ml of 2-butanone and are added dropwise. On completion of the addition, the dispersion is refluxed for 1 hour more. It is then cooled to about 60° C., the reflux condenser is exchanged for a Liebig condenser and the solvent is distilled off, a vacuum being applied toward the end of the distillation to remove residual solvent. The product remaining behind is comminuted in a mill. It has a carboxyl group content of 769 μeq/g.

### Example 7

To obtain comparative data in this example and in the example which follows, control filaments were spun, drawn and wound up under identical speed and temperature conditions by using a polymer which did not contain any inventive additives but otherwise had the same properties.

Nanocomposite chip obtained from 90 parts of nylon 6 and 10 parts of a modified, anhydrido-containing organophilic sheet-silicate reacted using a polyesterimide anhydride in accordance with Example 6 and having a relative solution viscosity (measured in sulfuric acid) of 3.06 and a melt flow index of 12 g/10 min was intensively dried in a vacuum drying cabinet (80° C., 8 hours) and spun on a high temperature spinning tester into monofilaments at a melt temperature of 259° C. and a spinning speed of 400 m/min which had a target linear density of about 45 dtex and were thereafter drawn on a Reifenhauser laboratory drawing apparatus by varying the process parameters of temperature and draw ratio.

The addition of modified sheet-silicate made it possible to achieve a significantly higher draw ratio which was also reflected in the strength values.

Table 1 shows the textile data of the drawn filaments.

TABLE 1
Production of polyamide monofils

| | 10% addition | null sample |
|---|---|---|
| Draw ratio | 1:4.87 | 1:3.67 |
| Linear density [tex] | 0.98 | 1.14 |
| Tenacity [cN/tex] | 78 | 65 |
| Initial modulus [MPa] | 3,540 | 2,467 |

### Example 8

The pellets of original PET (IV: 0.97; MFI: 23 g/10 min) and of a PET-nano sheet-silicate-LCP composite (IV: 1.03; MFI: 18 g/10 min), consisting of 90 parts of PET and 10 parts of a modified, anhydrido-containing organophilic sheet-silicate reacted using a polyesterimide anhydride in accordance with Example 6, were dried at 168° C. and 0.08 mbar for 24 hours and processed on a high temperature spinning tester to a target linear density of 4.4 dtex involving 6 individual filaments. The melt temperature was 295° C. and the takeoff speed was 400 m/min. The filaments thus produced were aged for 48 hours before being drawn on a laboratory drawing apparatus by varying the hotrail process temperature between 180 and 200° C. to determine the draw limit and the stable draw ratio. It was determined that the PET-nano sheet-silicate-LCP composites were drawable to a substantially higher draw ratio than the comparative PET. The textile values compared with the null sample are discernible from Table 2.

TABLE 2
Textile values of PET filaments

| | PET nanocomposite | null sample |
|---|---|---|
| Draw ratio | 1:3.95 | 1:3.08 |
| Linear density [tex] | 8.02 | 9.12 |
| Extension [%] | 24.2 | 31 |
| Tenacity [cN/tex] | 22.57 | 14.87 |

### Example 9

A PC-CU polycarbonate was intensively dried at 0.1 mbar and 160° C. in a vacuum drying cabinet for 8 hours. 90 parts of the pretreated polycarbonate were spun together with 10 parts of a modified, anhydrido-containing, organophilic montmorillonite, which had been reacted using a polyesterimide anhydride in accordance with Example 1, on a high temperature spinning tester at a melting temperature of 295° C. and a spinning speed of 400 m/min into monofilaments having a fineness of 1030 μm.

The addition of the specific, modified sheet-silicate made it possible to obtain a product having a tenacity of 18.5 cN/tex and an extension of 9.5%.

### Example 10

5 g of a modified hectorite synthetic three-layer mineral rendered organophilic with dimethylstearylbenzylammonium chloride in the manner described in Example 1 are mixed with 18 g of caprolactam and 72 g of nylon 66 salt and the mixture is melted under a 10 ml/min nitrogen stream with stirring. The melt is heated to 265° C. over 40 min and polycondensed for about 7.5 hours before being poured out of the stirred vessel. The copolyamide still contains 1.5% of extractables. It has a carboxyl group content of 76 μeq/g and an amino group content of 48 μeq/g. The relative solution viscosity is 2.05. The copolyamide has a melting point of 218° C.

We claim:

1. A process for producing nano-reinforced thermoplastic polymers, especially polyamides, polyesters or polycarbonates or copolymers thereof, comprising covalent bonding to or direct incorporation of modified sheet-silicates in nano distribution, wherein the hydroxyl groups on the surface of the sheet-silicates rendered organophilic by ion exchange are esterified with at least one compound selected from the group consisting of carboxylic acids, carboxylic anhydrides and anhydrido-bearing liquid-crystalline polyesterimide anhydrides.

2. A process as claimed in claim 1, wherein the modified sheet-silicates are added in amounts of 0.1 to 50% to the polymerization batch or polymer.

3. A process as claimed in claim 1, wherein the modified sheet-silicates are added in amounts of 0.5 to 5% to the polymerization batch or polymer.

4. A process as claimed in claim 1, wherein the sheet-silicate used is natural or synthetic or both natural and synthetic and is hydrophobicized by cation exchange.

5. A process as claimed in claim 4, wherein the sheet-silicate used is bentonite hydrophobicized by cation exchange.

6. A process as claimed in claim 1, wherein the carboxylic acids or carboxylic anhydrides are benzene-1,3,5-tricarboxylic acid, benzene-1,2,4-tricarboxylic acid (trimellitic acid) or its anhydride (trimellitic anhydride), benzene-1,2,4,5-tetracarboxylic acid (pyromellitic acid) or its dianhydrides (pyromellitic dianhydride), 3,3′,4,4′-benzophenone-tetracarboxylic dianhydrides, maleic anhydrides, pentanedioic acid, tetrahydropyran-2,6-dione, 5-(2,5-dioxotetrahydrofuryl)-3-methyl-3-cyclohexane or phthalic anhydrides.

7. A process as claimed in claim 1, wherein the free carboxylic acid or anhydride groups on the modified, organophilic sheet-silicates are reacted with a compound bearing two or more amino groups.

8. A process as claimed in claim 7, wherein the compound bearing two or more amino groups is 1,4-diaminobutane, 1,6-diaminohexane, 1,8-diaminooctane, 1,10-diaminodecane, 1,12-diaminododecane or isophoronediamine.

9. A process as claimed in claim 1, wherein the reactions of the organophilic sheet-silicates with at least one compound selected from the group consisting of carboxylic acids, carboxylic acid anhydrides and anhydrido-bearing liquid-crystalline polyesterimide anhydrides, and also, if appropriate, of the reaction products in a second step with amino-containing substances take place in solution or dispersion at temperatures between 20 and 200° C.

10. A process as claimed in claim 9, wherein the reactions take place between 160 and 180° C.

11. A process as claimed in claim 1, wherein the monomers used in the production of the thermoplastic polymers are lactams having 4 ring atoms or more such as C-caprolactam, enantholactam, capryllactam, lauryllactam or polyamide-forming combinations of C₆-C₁₂-dicarboxylic acids and/or cycloaliphatic and/or aromatic dicarboxylic acids with C₄-C₁₂-diamines and/or cycloaliphatic and/or aromatic diamines or mixtures thereof and also polyester-forming combinations of aliphatic and/or cycloaliphatic and/or aromatic dicarboxylic acids and diols.

12. A process as claimed in claim 1, wherein the modified sheet-silicate used is dispersed in the lactam melt and the polymerization batch is polymerized by the method of hydrolytic or anionic polymerization at temperatures between 68 and 300° C.

13. A process as claimed in claim 12, wherein the polymerization takes place between 180 and 240° C.

14. A process as claimed in claim 1, wherein the modified sheet-silicate serves as a polymerization initiator and becomes covalently bonded in the form of nanoparticles having an aspect ratio of more than 100 to the polymer chains which form.

15. A process as claimed in claim 12, wherein the polymerization batch has added to it further additives as initiators, activators or catalysts.

16. A process as claimed in claim 12, wherein the additives are selected from the group consisting of ε-aminocaproic acid, amine salts, cyclohexylamine hydrochloride, water, alkali or alkaline earth metals, hydrides, hydroxides, carbonates, Grignard compounds, N-acetylcaprolactam, N-caproylcaprolactam and N,N′-tetra-acetylhexamethylenediamine.

17. A process as claimed in claim 1, wherein the modified sheet-silicate is co-valently bonded in the form of nanoparticles into the resulting polymer together with dicarboxylic acids and diamines and/or with the salts of diamines and dicarboxylic acids and/or with amino acids in a polycondensation reaction at temperatures of 200 to 300° C.

18. A process as claimed in claim 15, wherein the polycondensation reaction takes place at temperatures of 240 to 280° C.

19. A process as claimed in claim 1, wherein the modified sheet-silicate is covalently bonded in the form of nanoparticles into the resulting polymer together with dicarboxylic acids and dihydroxy compounds in a polycondensation reaction at temperatures of 200 to 300° C.

20. A process as claimed in claim 17, wherein the polycondensation reaction takes place at temperatures of 240 to 280° C.

21. A process as claimed in claim 1, wherein the liquid-crystalline polyesterimide anhydrides are less than 800 nm in diameter.

22. A process as claimed in claim 19, wherein the liquid-crystalline polyesterimide anhydrides are less than 400 nm in diameter.

23. A process as claimed in claim 1, wherein the nano-reinforced polymers are processed into shaped articles.

24. A process as claimed in claim 23, wherein the shaped articles are fibers, filaments, injection moldings or free-standing films.

25. A process as claimed in claim 1, wherein the nano-reinforced polymers are blended with other similar or compatible polymers and further processed into shaped articles.

26. A process as claimed in claim 25, wherein the shaped articles are fibers, filaments, injection moldings or free-standing films.

27. A process as claimed in claim 1, wherein waste material composed of the nano-reinforced polymers is singly or multiply reshaped.
